(19) United States
(12) Patent Application Publication
(10) Pub. No.: US 2023/0084443 A1
(43) Pub. Date: Mar. 16, 2023

(54) Interactive Computerized Toy

(71) Applicant: Eyal Shlomot, Long Beach, CA (US)

(72) Inventor: Eyal Shlomot, Long Beach, CA (US)

(21) Appl. No.: 17/898,494

(22) Filed: Aug. 30, 2022

Related U.S. Application Data
(60) Provisional application No. 63/239,914, filed on Sep. 1, 2021.

(51) Int. Cl. A63F 9/24; G06F 3/0488; A63H 33/26

(52) U.S. Cl. CPC A63F 9/24; G06F 3/0488; A63H 33/26; A63H 2200/00; A63F 2009/241; A63F 2009/2454; A63F 2009/247

(57) ABSTRACT

This invention describes an interactive computerized toy that provides light, audio and vibration entertaining patterns in response to touch stimuli from all directions and where the light patterns may be displayed in all directions. In particular, the present invention describes an interactive computerized toy in the shape of a cube with six faces with a unique versatility in providing endless programming options, in a fashion similar to loading and playing different games on the screens of handheld devices such as smartphones.

### CROSS-REFERENCE TO RELATED APPLICATIONS

This application claims the priority benefits of U.S. Provisional Application No. 63/239,914 filed on Sep. 1, 2021, which is incorporated herein in its entirety by reference.

### FIELD OF THE INVENTION

The present invention relates to interactive toys and more particularly to an interactive computerized toy such that the player of the toy can interact with the toy using touch, motion and audio stimuli to create light, audio and vibration entertaining experiences.

### BRIEF DESCRIPTION OF THE INVENTION

The present invention describes an interactive computerized toy that provides light, audio and vibration entertaining patterns in response to touch that is applied to the toy from several directions, to the motion of the toy and to audio input to the toy, wherein the light patterns may be displayed in all directions. Such an interactive computerized toy may be of a ball shape, elongated (ellipse) ball shape, any of the Platonic solid shapes (tetrahedron shape, cube shape, octahedron shape, dodecahedron shape, or icosahedron shape), or any other multi-face shape such that each face points to a different direction, which allows the player of the interactive computerized toy to access, touch and look at the interactive computerized toy from all directions. In particular, and without a loss of generality, the present invention describes in details an interactive computerized toy in the shape of a cube with six faces that are tiled with touch points, where each touch point includes an LED and a metal component which may be of a ring shape. The cube-shaped interactive computerized toy may incorporate several components, such as a microcontroller unit (MCU), a motion and orientation detection device, audio interfaces, a vibration motor and a radio connection to a handheld device (such as a smartphone). As the player touches different touch points on the faces of the cube-shaped interactive computerized toy and moves the cube-shaped interactive computerized toy in different directions, varying LED patterns, played audio and vibrations are produced based on the detected touch applied to the cube-shaped interactive computerized toy, the motion of the cube-shaped to interactive computerized toy and the orientation of the cube-shaped interactive computerized toy, to provide entertaining experiences to the player. The entertaining experiences, such as a variety of interactive games, may be set up by the handheld device, where an app can be used to choose between different interactive games. In addition, the interactive games may also be controlled by audio input from the player.

In a sense, each face of this example of a cube-shaped interactive computerized toy can be considered as a low-resolution touch screen. Therefore, each face by itself and all the faces of the cube-shaped interactive computerized toy as a whole can be programmed to play different games, similar to the way different games can be loaded to a handheld device and played on the touch screen of the handheld device. Of course, unlike the touch screen of a handheld device, the games played on this example of cube-shaped interactive computerized toy can take a particular advantage of the structure of the cube-shaped interactive computerized toy and can use all of its six faces for extremely entertaining games that utilize the complete spherical access (“360°” access in the 3-dimensional space) to all the sides of the cube-shaped interactive computerized toy.

### BRIEF DESCRIPTION OF THE DRAWINGS

Smart computerized toys that provide interactive entertaining features are common in the marketplace. This invention describes an interactive computerized toy that provides light, audio and vibration entertaining patterns in response to touch stimuli from all directions and where the light patterns may be displayed in all directions. Without a loss of generality, the present invention describes in details an interactive computerized toy in the shape of a cube with six faces with a unique versatility in providing endless programming options, in a fashion similar to loading and playing different games on the screens of handheld devices such as smartphones.

While the detailed description of the interactive computerized toy concentrates on the example of a cube-shaped interactive computerized toy, without any loss of generality, any of the details in the description of the cube-shaped interactive computerized toy can be applied to an interactive computerized toy of a different shape with different interactive surfaces that form a multi-face structure for the user touch and for the display of light patterns. The features and advantages of the present invention will become more readily apparent to those ordinarily skilled in the art after reviewing the following detailed description and accompanying drawings, wherein:

FIG. 1 is a schematic diagram of a cube-shaped interactive computerized toy where the six faces of the cube are tiled in a square-pattern of touch points with an LED at the center of each touch point.

FIG. 2 is a schematic diagram of the components of the cube-shaped interactive computerized toy.

FIG. 3 is a schematic diagram of the repeated processing steps performed by the cube-shaped interactive computerized toy.

### DETAILED DESCRIPTION OF THE INVENTION

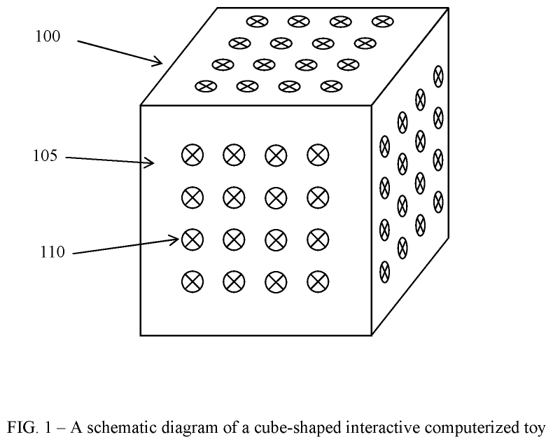

The present invention describes an interactive computerized toy with a multi-face shape such that each face points to a different direction, which allows the player of the interactive computerized toy to access, touch and look at the interactive computerized toy from all directions. The interactive computerized toy provides light, audio and vibration entertaining patterns in response to motion stimuli and to touch stimuli that may be applied from all directions. Similarly, the light patterns may be displayed in all directions. In addition, the entertaining patterns may be controlled by an audio input to the interactive computerized toy. FIG. 1 is a schematic diagram of a specific cube-shaped interactive computerized toy 100. Cube-shaped interactive computerized toy 100 has six square faces (such as square face 105), where each face is tiled with touch points 110. Each of touch points 110 consists of a conductive-metal component, an LED and an optional semi-transparent cover. Face 105 can be considered as a touch screen, similar in its properties to a touch screen of a smartphone, but with a much larger pixel size and at a much lower resolution. In particular, in one embodiment of the current invention, touch points 110 are organized as 9-by-9 matrix, such the number of touch points 110 on face 105 is 81 touch points and the total number of touch points 110 on cube-shaped interactive computerized toy 100 is 486 touch points.

The conductive-metal component, which may be a metal ring, is used for the detection of a touch by the player finger, using the well known approach of capacitive touch detecting, which is based on measuring the timing of voltage changes over the capacitor that is created between the conductive-metal component and the finger of the player. Differences in timing of voltage changes are used to generate touch-detect parameters from touch points 110 on face 105 and, in generalization, from all touch points 110 on the six faces of cube-shaped interactive computerized toy 100. The generating of the touch-detect parameters is controlled by touch-detect setup-information, which may include, for example, voltage thresholds information or timing thresholds information.

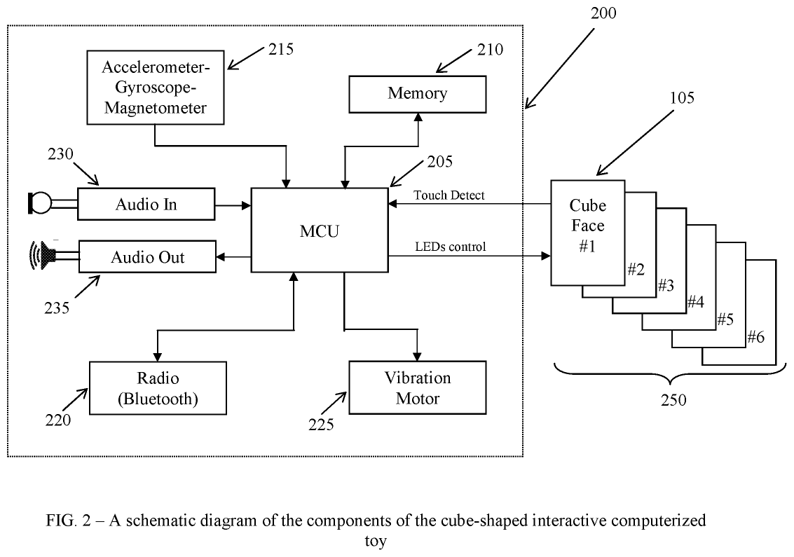

FIG. 2 is schematic diagram of the components of cube-shaped interactive computerized toy 100. Core 200 of cube-shaped interactive computerized toy 100 comprises of computation device such as microcontroller component (MCU) 205, memory 210, accelerometer-gyroscope-magnetometer 215, radio component 220 (which may be a Bluetooth radio component), vibration motor 225, audio in component 230 and audio out component 235. Audio in component 230 may include a microphone, an amplifier and an analog-to-digital (A/D) converter. Audio out component 235 may include a digital-to-analog (D/A) converter, an amplifier and a loudspeaker. Accelerometer-gyroscope-magnetometer 215, commonly called nine-degree-of-freedom (9DoF) device, is a device that incorporates three-devices into one package that contains an accelerometer that provides acceleration measurements in three Cartesian axes, a gyroscope that provides angular-velocity measurements in three Polar coordinates and a magnetometer that provides magnetic-field measurements in three Cartesian axes. The operation of accelerometer-gyroscope-magnetometer 215 is controlled by accelerometer setup-information, magnetometer setup-information and gyroscope setup-information, which sets up accelerometer-gyroscope-magnetometer 215 to the preferred operating modes, where the setup-information may include the sensitivity of the measurements of the acceleration parameters and other parameters, or the desired sampling frequency of measuring the parameters. The accelerometer setup-information, magnetometer setup-information and gyroscope setup-information may be received by radio component 220, where these setup-information are provided by a handheld device. The accelerometer setup-information, magnetometer setup-information and gyroscope setup-information may also be provided to MCU 205 via audio in component 230, where spoken words or audio cues may be interpreted by MCU 205 to generate these setup-information. MCU 205 communicates with face 105, as well as with all six faces 250 of cube-shaped interactive computerized toy 100, to receive the touch-detect parameters from touch points 110. MCU 205 also receives the acceleration measurements, the magnetic-field measurements and the angular-velocity measurements from accelerometer-gyroscope-magnetometer 215. MCU 205 then uses the received measurement to generate and to provide the LEDs control signals for the LEDs in touch points 110 that display light patterns on six faces 205, an audio control signal for audio out component 235 that produces audio on a loudspeaker and a vibrating control signal for vibration motor 225 that vibrates cube-shaped interactive computerized toy 100.

The generation of the LEDs control signals by MCU 205 for the LEDs in touch points 110, the audio control signal for audio out component 235 and the vibrating control signal for vibration motor 225 is different for each mode of operation of cube-shaped interactive computerized toy 100, depending on the desired entertaining patterns that are required for each mode of operation, which is simply the different game that is played on cube-shaped interactive computerized toy 100 or the different audio-visual show produced by cube-shaped interactive computerized toy 100 during a particular game. For example, in one game a specific LED may be turned to a red color, while in another game the same LED may be turned to a blue color. Similarly, the audio played by audio out component 235 may be a type of music in one game, a ringing effect in another game or spoken words in yet a third game. The different control signals that are generated by MCU 205 are based on different control setup-information, such as LEDs control setup-information to set up the LEDs control signals for the LEDs in touch points 110, audio control setup-information to set up the audio control signal for audio out component 235 and vibrating control setup-information to set up the vibrating control signal for vibration motor 225. These control setup-information may be received by radio component 220, where the control setup-information is provided by a handheld device. The control setup-information may also be provided to MCU 205 via audio in component 230, where spoken words or audio cues may be interpreted by MCU 205 to generate these control setup-information. For example, the brightness or the colors of the light produced the LEDs in touch points 110 may be set by numerical spoke command or may be set according to the volume of the audio received by audio in component 230. In addition, cube-shaped interactive computerized toy 100 may include a photoelectric component (not depicted in FIG. 2) that measures the ambient light around cube-shaped interactive computerized toy 100 and that may provide additional setup-information to MCU 205. For example, the brightness of the light produced the LEDs in touch points 110 may be set according to the ambient light to improve the visibility of the light produced the LEDs in touch points 110.

Obviously, it is possible to operate cube-shaped interactive computerized toy 100 with only a partial set of the parameters. For example, for some games the measurements from accelerometer-gyroscope-magnetometer 215 may not be used at all, or only the acceleration measurements (or only the acceleration and magnetic-field measurements) may be used to generate the LEDs control signals for the LEDs in touch points 110, the audio control signal for audio out component 235 and the vibrating control signal for vibration motor 225. Similarly, it is possible that the touch-detect parameters from only some of touch points 110 will be used to generate the control signals. For example, it is possible that touch parameters only from specific touch points of touch points 110 on a face of all faces 205 that are relevant for the game played on that face may be used. In another example, it is possible not to use at all the touch-detect parameters from the face (from all faces 205) that is pointing downward.

The operation of cube-shaped interactive computerized toy 100 is controlled by MCU 205, which receives the motion and orientation parameters from accelerometer-gyroscope-magnetometer 215 and the touch-detect parameters from touch points 110 on six faces 250. MCU 205 processes the parameters to generate the LEDs control signals to activate the LEDs in touch points 110 to display light in all directions, to generate the audio control signal for audio out component 235 to produce audio on a loudspeaker and to general the vibrating control signal for vibration motor 225 to vibrate cube-shaped interactive computerized toy 100. The control signals are generated to provide the entertaining experiences for the player of cube-shaped interactive computerized toy 100. A key property of cube-shaped interactive computerized toy 100 is the ability to change its mode of operation, i.e., to use different program to operate it, which provide practically endless different entertaining experiences, which are simply different games the player can play. These different games are similar to the games currently played on the screen of a smartphone, but that can be played on all six faces 250 (i.e., touch from all directions can be detected and light can be displayed to all directions), albeit at much lower resolution than games played on the screen of a smartphone. For example, in pattern matching games for toddlers, the pattern options may be displayed on all six faces 250, challenging the toddler to manipulate cube-shaped interactive computerized toy 100 in all directions to search and to find the correct pattern. The famous “snake” game may be played such that the “snake” can move from one face to another face and therefore circumnavigate cube-shaped interactive computerized toy 100 in patterns that are much more entertaining than in playing the “snake” game on the flat screen of a handheld device. The famous “Tetris” game may be played on all six faces 250 of the cube-shaped interactive computerized toy 100, where the motion of the Tetris game pieces may be controlled by the tilting of the cube-shaped interactive computerized toy 100 in different directions.

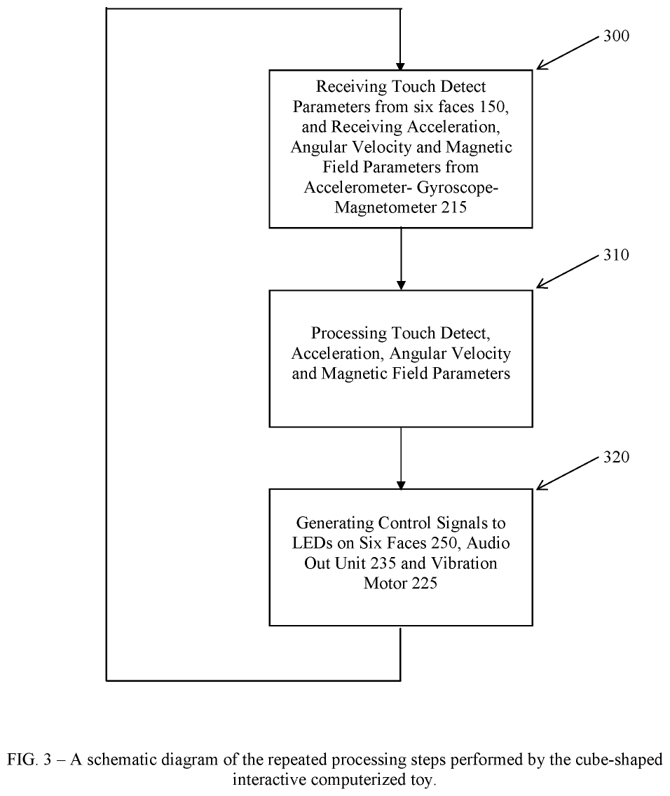

FIG. 3 is a schematic diagram of the repeated processing steps performed by cube-shaped interactive computerized toy 100. The processing steps are performed by MCU 205, which may also utilize memory 210. At step 300, the touch-detect parameters from touch points 110 on six faces 250 and the acceleration, angular-velocity and magnetic-field parameters from accelerometer-gyroscope-magnetometer 215 are received by MCU 205. It is important to note that in some operation modes all the parameters may be required and received, while in other operation modes only some of the parameters may be required and received. For example, in some operation modes the touch-detect parameters may be required and received from only few touch points 110 on six faces 250. In an additional example, in some operation modes the magnetic-field and angular-velocity parameters may not be required and will not be received. At step 310 the parameters received are processed by MCU 205. It is important to note that the processing includes parameters that were obtained during previous iterations of the repeated steps. For example, touch detect parameters from several different touch points 110, from several previous iterations and from the current iteration may be processed to indicate a finger sliding along face 105. At step 320, MCU 205 generates the LEDs control signals for the LEDs on six faces 250, the audio control signal for audio out component 235 and the vibrating control signal for vibration motor 225.

As discussed above, a key feature of the operation of cube-shaped interactive computerized toy 100 is its ability to operate in numerous different modes of operations, which is the ability to provide practically unlimited number of different games for the user to play on cube-shaped interactive computerized toy 100. Operating in different modes, i.e., playing different games, is optionally achieved by using different setup-information by all the components of cube-shaped interactive computerized toy 100. In particular, MCU 205 receives different parameters that are based on the setup-information in step 300 and MCU 205 performs different processing in step 310 to generating different control signals in step 320 based on the setup-information, which is very similar to the way different games are played on a handheld device such as a smartphone. The setup-information includes the touch-detect setup-information, the accelerometer setup-information, the magnetometer setup-information, the gyroscope setup-information, the LEDs control setup-information, the audio control setup-information and the vibration control setup-information. Obviously, for any mode, or game played, on cube-shaped interactive computerized toy 100, only the setup-information required for that game is needed. To operate in a different mode, MCU 205 may use different setup-information, wherein the setup-information may consist of a different program to be used by MCU 205 or different numerical factors, such as thresholds, to be use by a specific program. The different setup-information may be stored in memory 210 or may be provided to MCU 205 from a handheld device that is connected to MCU 205 by radio component 220. In essence, the player may use an application on the handheld device to select a game to play and the handheld device may send the setup-information to MCU 205 via radio component 220, such that MCU 205 repeatedly executes steps 300 through 320 to provide the selected game experience to the player. As described above, the setup-information may be provided to MCU 205 by audio in component 230, using spoken words of audio cues to select different modes of operations for playing different games by the user of cube-shaped interactive computerized toy 100.

Without a loss of generality, the choice of different games for cube-shaped interactive computerized toy 100 by radio component 220 may be done most conveniently using an app on a handheld device that will use its radio component to communicate with MCU 205 via radio component 220 on cube-shaped interactive computerized toy 100. Any radio communication protocol may be used, but one suitable example may be the Bluetooth radio communication protocol. The radio communication between cube-shaped interactive computerized toy 100 and the handheld device may also be used to send status-information from cube-shaped interactive computerized toy 100 to the handheld device. The status-information may be used by the handheld device for optimal execution of the app and for reporting information to the player or the players of a particular game on cube-shaped interactive computerized toy 100. The status-information may be diagnostic in nature, such as the charging level of the battery of cube-shaped interactive computerized toy 100 or possible malfunctioning of any of the components of cube-shaped interactive computerized toy 100. The status-information may also be score keeping of specific competitive games on cube-shaped interactive computerized toy 100. In addition, the status-information may be used to communicate with other players that use different cube-shaped interactive computerized toy 100 in different locations, such as in playing a “Battelship” game on two or more different cube-shaped interactive computerized toy 100 in different locations.

1. An interactive computerized toy, comprising:
a multi-face structure, wherein each face points to a different direction, wherein each face comprises a plurality of touch points, wherein each touch point comprises an LED and a conductive-metal component and wherein the plurality of touch points is configured to generate a plurality of touch detect parameters;
an audio out device configured to produce audio by a loudspeaker;
a computation device configured to receive the plurality of touch detect parameters and to generate LEDs control signals for the LEDs in the plurality of touch points based on the received plurality of touch-detect parameters and to generate an audio control signal to the audio out device based on the received plurality of touch-detect parameters.

2. The interactive computerized toy of claim 1, further comprising,
an accelerometer configured to measure acceleration parameters of the interactive cube-shaped computerized toy, wherein the computation device is further configured to receive the acceleration parameters and to further generate the LEDs control signals for the plurality of LEDs in the plurality of touch points based on the received acceleration parameters and to further generate the audio control signal to the audio out device based on the received acceleration parameters.

3. The interactive computerized toy of claim 1, further comprising,
a magnetometer configured to measure magnetic-field parameters for the interactive computerized toy, wherein the computation device is further configured to receive the measured magnetic-field parameters and to further generate the LEDs control signals for the plurality of LEDs in the plurality of touch points based on the received magnetic-field parameters and to further generate the audio control signal to the audio out device based on the received magnetic-field parameters.

4. The interactive computerized toy of claim 1, further comprising,
a gyroscope configured to measure angular-velocity parameters for the interactive computerized toy, wherein the computation device is further configured to receive the measured angular-velocity parameters and to further generate the LEDs control signals for the plurality of LEDs in the plurality of touch points based on the received angular-velocity parameters and to further generate the audio control signal to the audio out device based on the received angular-velocity parameters.

5. The interactive computerized toy of claim 1, wherein the generating of the plurality of touch-detect parameters is based on a touch-detect setup-information, wherein the generating of the LEDs control signals for the plurality of LEDs on the multi-face structure is further based on an LEDs control setup-information and wherein the generating of the audio control signal to the audio out device is further based on an audio control setup-information.

6. The interactive computerized toy of claim 2, wherein the measuring of the acceleration parameters is based on an accelerometer setup-information, wherein the generating of the LEDs control signals for the plurality of LEDs on the multi-face structure is further based on an LEDs control setup-information and wherein the generating of the audio control signal to the audio out device is further based on an audio control setup-information.

7. The interactive computerized toy of claim 5, further comprising,
a radio component configured to communicate with a handheld device to receive the touch-detect setup-information and at least one of the LEDs control setup-information and the audio control setup-information.

8. The interactive computerized toy of claim 6, further comprising,
a radio component configured to communicate with a handheld device to receive the accelerometer setup-information and at least one of the LEDs control setup-information and the audio control setup-information.

9. The interactive computerized toy of claim 5, further comprising,
an audio component configured to provide audio to the computation device, wherein the computation device is further configured to interpret the received audio to generate the touch-detect setup-information and at least one of the LEDs control setup-information and the audio control setup-information.

10. The interactive computerized toy of claim 6, further comprising,
an audio component configured to provide audio to the computation device, wherein the computation device is further configured to interpret the received audio to generate the accelerometer setup-information and at least one of the LEDs control setup-information and the audio control setup-information.

11. The interactive computerized toy of claim 1, wherein at least one of the conductive-metal component in the plurality of touch points is a metal ring and wherein the generating of the plurality of touch detect parameters is based on measuring time of a voltage change on the metal ring.

12. A method for generating control signals in an interactive computerized toy, the method comprises:
generating a plurality of touch-detect parameters by a plurality of touch points on a multi-face structure of the interactive computerized toy, wherein each face points to a different direction and wherein each of the plurality of touch points comprises of an LED and a conductive-metal component;
receiving the plurality of touch-detect parameters by a computation device;
generating LEDs control signals for the LEDs in the plurality of touch points by the computation device based on the received plurality of touch-detect parameters and generating an audio control signal to an audio out device by the computation device based on the received plurality of touch-detect parameters.

13. The method of claim 12, further comprising:
measuring acceleration parameters for the interactive multi-face computerized toy by an accelerometer;
receiving the acceleration parameters by a computation device;
further generating the LEDs control signals for the LEDs in the plurality of touch points by the computation device based on the received plurality of acceleration parameters and further generating the audio control signal to the audio out device by the computation device based on the received plurality of acceleration parameters.

14. The method of claim 12, further comprising:
measuring magnetic-field parameters for the interactive multi-face computerized toy by a magnetometer;
receiving the magnetic-field parameters by a computation device;
further generating the LEDs control signals for the LEDs in the plurality of touch points by the computation device based on the received magnetic-field parameters and further generating the audio control signal to the audio out device by the computation device based on the received magnetic-field parameters.

15. The method of claim 12, wherein the generating of the plurality of touch-detect parameters is based on a touch-detect setup-information, wherein the generating of the LEDs control signals for the LEDs in the plurality of touch points is further based on an LEDs control setup-information and wherein the audio control signal to the audio out device is further based on an audio control setup-information.

16. The method of claim 13, wherein the measuring of the acceleration parameters is based on an accelerometer setup-information, wherein the generating of the LEDs control signals for the LEDs in the plurality of touch points is further based on an LEDs control setup-information and wherein the audio control signal to the audio out device is further based on an audio control setup-information.

17. The method of claim 15, further comprising:
receiving the touch-detect setup-information and at least one of the LEDs control setup-information and the audio control setup-information by a radio component.

18. The method of claim 15, further comprising:
receiving audio by the computation device from an audio in component and interpreting the received audio to generate the touch-detect setup-information and at least one of the LEDs control setup-information and the audio control setup-information.

19. The method of claim 16, further comprising:
receiving the accelerometer setup-information and at least one of the LEDs control setup-information and the audio control setup-information by a radio component.

20. The method of claim 16, further comprising:
receiving audio by the computation device from an audio in component and interpreting the received audio to generate the accelerometer setup-information and at least one of the LEDs control setup-information and the audio control setup-information.
